(19) United States
(12) Patent Application Publication
(10) Pub. No.: US 2011/0069420 A1
(43) Pub. Date: Mar. 24, 2011

(54) PROTECTION TO A POWER CONVERTER BY USING A HIGH-VOLTAGE START-UP DEVICE IN A CONTROLLER CHIP OF THE POWER CONVERTER

(75) Inventors: KUO-CHIN CHIU, HSINCHU COUNTY (TW); CHIH-FENG HUANG, HSINCHU COUNTY (TW)

(73) Assignee: RICHPOWER MICROELECTRONICS CORPORATION, GRAND CAYMAN (KY)

(21) Appl. No.: 12/884,688

(22) Filed: Sep. 17, 2010

(30) Foreign Application Priority Data
Sep. 22, 2009 (TW) 098131889

(51) Int. Cl. H02H 3/20; H02H 3/00; H02H 3/24

(52) U.S. Cl. 361/91.1; 361/88; 361/92

(57) ABSTRACT

A controller chip provides protection to a power converter by using a high-voltage start-up device in the controller chip, without additional pins or external elements of the controller chip. A JFET is used as the high-voltage start-up device connected between a high-voltage pin and a power input pin of the controller chip, to charge a power capacitor connected to the power input pin at power on. The controller chip monitors the voltage at the power input pin and turns off the JFET once the voltage at the power input pin increases to reach a threshold. Thereafter, the source voltage of the JFET will reflect the voltage at the high-voltage pin, and a protection circuit monitors the source voltage of the JFET to trigger a protection signal.

### FIELD OF THE INVENTION

The present invention is related generally to a power converter and, more particularly, to a controller chip and protection method for a power converter.

### BACKGROUND OF THE INVENTION

In a conventional AC-to-DC power converter, as shown in FIG. 1, the AC voltage VAC supplied to the power converter is filtered and rectified into a DC voltage VDC to be applied to the primary coil Lp of a transformer T1, and a controller chip 10 has a driver 18 to provide a control signal Vgate to switch a power switch Q1 to convert the voltage VDC into an output voltage Vo at the secondary side. In the controller chip 10, a high-voltage start-up device 16 is connected between a high-voltage pin HV and a power input pin VDD to start up the control chip 10 during the power-on state of the AC voltage VAC. After the controller chip 10 is turned on, an auxiliary coil Laux will generate a current that flows through a resistor R1 and a diode D1 to charge a power capacitor C1, thereby supplying electric power to the controller chip 10. In the AC-to-DC power converter, to avoid malfunctions of the load circuit caused by under-voltage condition of the DC voltage VDC, a brownout detector 12 is added to monitor the DC voltage VDC. The brownout detector 12 includes resistors R2, R3 and R4 and a hysteresis comparator 14. The resistors R2, R3 and R4 establish a voltage divider to divide the DC voltage VDC to generate a voltage V1, and the hysteresis comparator 14 compares the voltage V1 with a threshold Vref to assert a protection signal Sc to turn off he driver 18. As the brownout detector 12 requires the external resistors R2, R3 and R4 and the controller chip 10 needs an additional pin EN to receive the voltage V1, the AC-to-DC power converter is of higher cost. The brownout detector 12 also consumes additional power since the resistors R2, R3 and R4 always have a current flowing therethrough.

### SUMMARY OF THE INVENTION

An object of the present invention is to provide a controller chip for a power converter.

Another object of the present invention is to provide a protection method for a power converter.

According to the present invention, a controller chip for a power converter includes a high-voltage pin, a power input pin and a junction field effect transistor (JFET) as a high-voltage start-up device connected between the high-voltage pin and the power input pin. The JFET has a drain connected to the high-voltage pin, and a source connected to an anode of a diode whose cathode connected to both a gate of the JFET and the power input pin. A protection circuit monitors the voltage at the source to assert a protection signal, and a detector monitors the voltage at the power input pin to switch the JFET.

According to the present invention, a protection method for a power converter includes charging a power capacitor through a JFET at power on, turning off the JFET when the voltage at the power capacitor increases to reach a threshold, and monitoring the voltage at a source of the JFET after the JFET is turned off, to trigger a protection signal.

By using the high-voltage start-up device already present in the controller chip to implement protection functions for the power converter, there is no need of additional pins or external elements of the controller chip to protect the power converter.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a circuit diagram of a conventional AC-to-DC power converter;

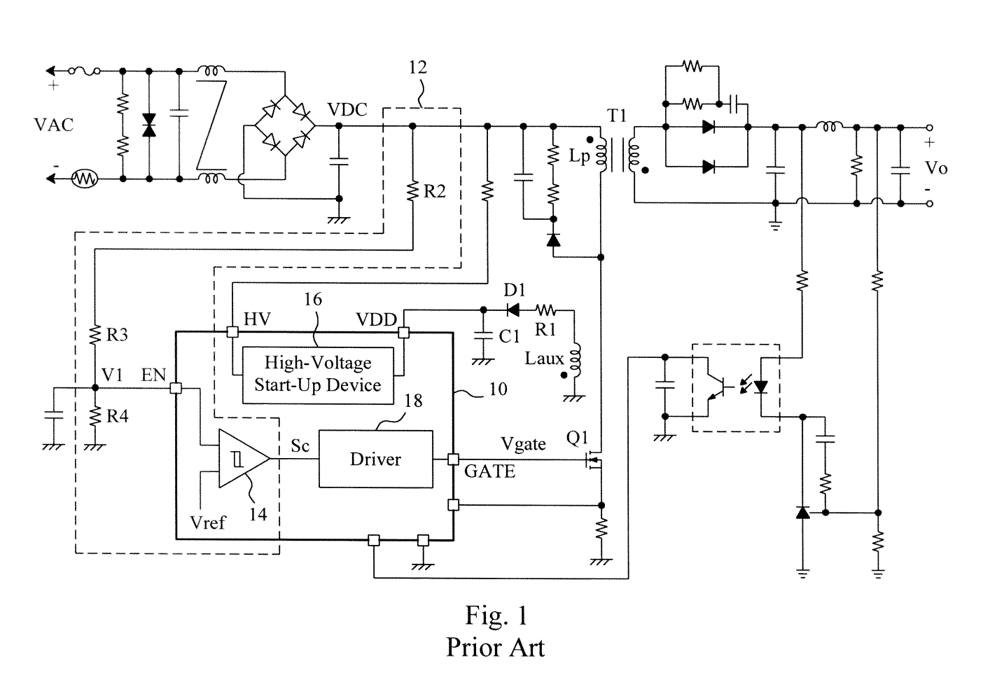

FIG. 2 is a circuit diagram of an embodiment according to the present invention; and

FIG. 3 shows a characteristic curve of the threshold voltage-drain voltage of a JFET.

### DETAILED DESCRIPTION OF THE INVENTION

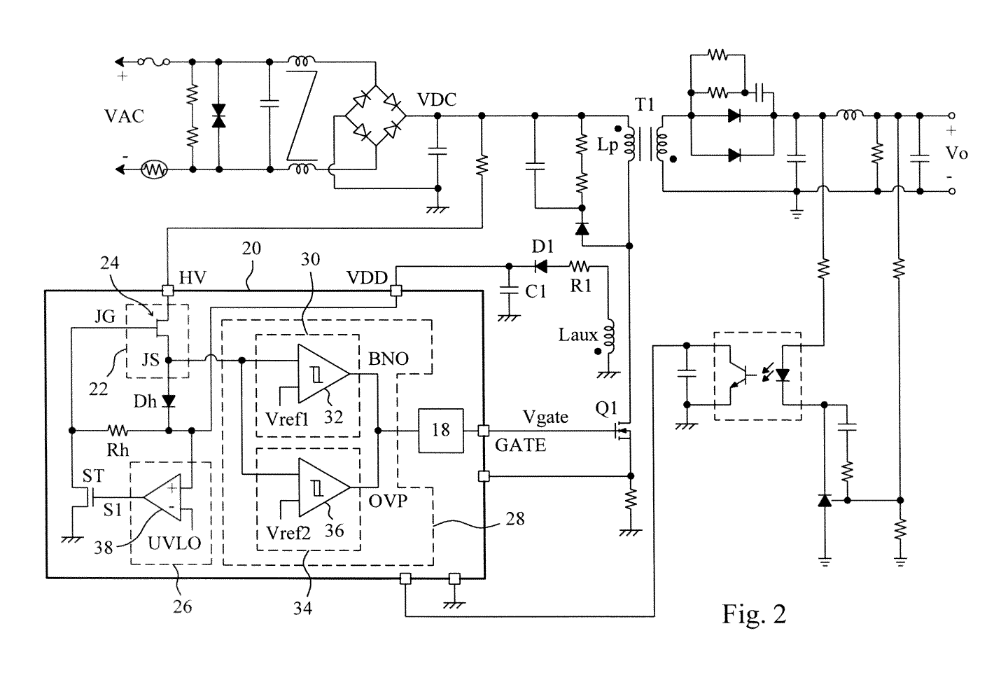

FIG. 2 shows an application of the present invention, in which a power converter uses a controller chip 20 that implements protection to the power converter with a different mechanism from that employed in prior arts. In the controller chip 20, a junction field effect transistor (JFET) 24 is used as a high-voltage start-up device 22, which has a drain connected to a high-voltage pin HV, a source connected to an anode of a diode Dh, and a gate receiving a voltage JG, a current-limiting resistor Rh is connected between a cathode of the diode Dh and the gate of the JFET 24, the cathode of the diode Dh is also connected to a power input pin VDD, a switch ST is connected between the gate of the JFET 24 and ground, a detector 26 detects the voltage at the power input pin VDD to determine a detection signal S1 to switch the switch ST, and a protection circuit 28 monitors the source voltage JS at the source of the JFET 24 to assert a protection signal. The protection circuit 28 includes a brownout detector 30 and an over-voltage detector 34. The brownout detector 30 has a hysteresis comparator 32 to compare the source voltage JS with a brownout threshold Vref1 to assert a brownout protection signal BNO to turn off the driver 18. The over-voltage detector 34 has a hysteresis comparator 36 to compare the source voltage JS with an over-voltage threshold Vref2 to assert an over-voltage protection signal OVP for the driver 18.

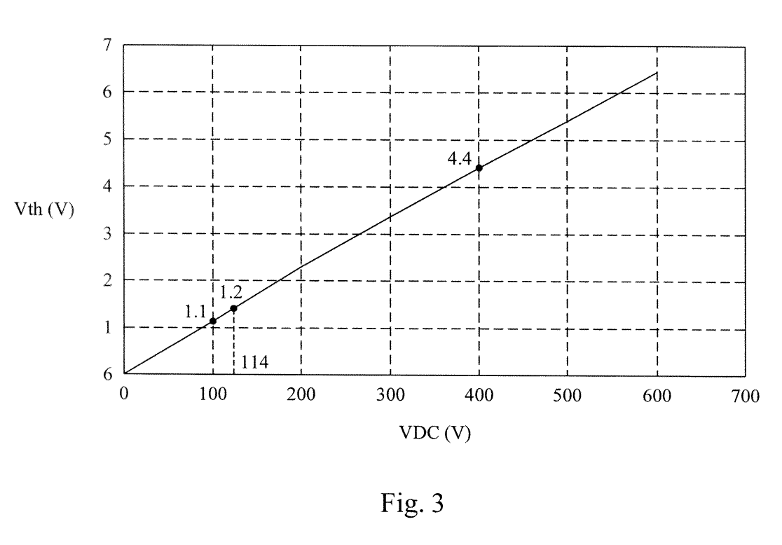

Based on the characteristic of the JFET 24, the threshold voltage Vth of the JFET 24 depends on the drain voltage VDC of the JFET 24, as shown by the characteristic curve of FIG. 3. Referring to FIGS. 2 and 3, immediately after an AC voltage VAC is supplied to the power converter at power on, the gate voltage JG of the JFET 24 will be equal to or substantially equal to the source voltage JS of the JFET 24 and thus the JFET 24 is turned on, thereby allowing a current flowing through the JFET 24, the diode Dh and the power input pin VDD to charge the power capacitor C1. The detector 26 detects the voltage VDD at the power capacitor C1, for example by using a comparator 38 to compare the voltage VDD with a threshold UVLO. When the voltage VDD increases to reach the threshold UVLO, the detector 26 triggers the detection signal S1 to turn on the switch ST and thereby pull the gate voltage JG of the JFET 24 to 0V. As a result, the JFET 24 is turned off, i.e., no longer conducts a current therethrough, to save power. At this moment, the voltage VDD at the power capacitor C1 is sufficiently high to start up the controller chip 20, so the driver 18 is turned on to provide a control signal Vgate to switch the power switch Q1 and thereby start up the auxiliary coil Laux to supply electric power to the controller chip 20. Thus, the start-up process of the power converter is completed.

After the power converter is started up, the gate voltage JG of the JFET 24 is 0V and the voltage at the power input pin VDD is higher than the threshold UVLO, such that the source voltage JS of the JFET 24 is locked at the threshold voltage Vth of the JFET 24, as shown in FIG. 3. Since the threshold voltage Vth of the JFET 24 varies with the DC voltage VDC, the brownout detector 30 can identify whether or not the DC voltage VDC is excessively low by detecting the source voltage JS of the JFET 24. For instance, assuming that the brown-in level is 114V and the brownout level is 100V, it can be known from FIG. 3 that the source voltage JS is approximately 1.2V when the voltage VDC is 114V and the source voltage JS is approximately 1.1V when the voltage VDC is 100V. Therefore, if the hysteresis comparator 32 in the brownout detector 30 detects that the source voltage JS is higher than 1.2V, the driver 18 will work normally; however, if the hysteresis comparator 32 detects that the source voltage JS is lower than 1.1V, the brownout protection signal BNO will be triggered to turn off the driver 18. Similarly, the over-voltage detector 34 can identify whether or not the voltage VDC is excessively high by detecting the source voltage JS. Assuming that the over-voltage level is set at 400V, it can be known from FIG. 3 that the source voltage JS is approximately 4.4V when the voltage VDC is 400V. Hence, if the hysteresis comparator 36 in the over-voltage detector 34 detects that the source voltage JS is higher than 4.4V, the over-voltage protection signal OVP will be triggered to turn off the driver 18.

In this embodiment, brownout protection and over-voltage protection are illustrated by way of example only; it is also feasible to provide other types of protection to the power converter, such as overload protection compensation by detecting the source voltage JS of the JFET 24. In this embodiment, the controller chip 20 provides protection by monitoring the DC voltage VDC via the high-voltage pin HV; in other embodiments, it may do it by monitoring the AC voltage VAC or the drain voltage of the power switch Q1.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A controller chip for a power converter, comprising:
a high-voltage pin;
a JFET as a high-voltage start-up device, having a drain connected to the high-voltage pin;
a power input pin;
a diode having an anode connected to a source of the JFET and a cathode connected to both a gate of the JFET and the power input pin;
a protection circuit connected to the source of the JFET, operative to monitor a voltage at the source to trigger a protection signal; and
a detector connected to the power input pin, for detecting a voltage at the power input pin to trigger a detection signal to switch the JFET.

2. The controller chip of claim 1, wherein the protection circuit comprises a brownout detector connected to the source of the JFET, for detecting the voltage at the source to trigger the protection signal.

3. The controller chip of claim 2, wherein the brownout detector comprises a hysteresis comparator connected to the source of the JFET, for comparing the voltage at the source with a brownout threshold.

4. The controller chip of claim 1, wherein the protection circuit comprises an over-voltage detector connected to the source of the JFET, for detecting the voltage at the source to trigger the protection signal.

5. The controller chip of claim 4, wherein the over-voltage detector comprises a hysteresis comparator connected to the source of the JFET, for comparing the voltage at the source with an over-voltage threshold.

6. The controller chip of claim 1, wherein the detector comprises a comparator connected to the power input pin, for comparing the voltage at the power input pin with a threshold.

7. The controller chip of claim 1, further comprising a switch connected between the gate of the JFET and ground, controlled by the detection signal.

8. The controller chip of claim 1, further comprising a resistor connected between the gate and the source of the JFET.

9. A protection method for a power converter, comprising the steps of:
(A) charging a power capacitor through a JFET at power on;
(B) detecting a voltage at the power capacitor;
(C) turning off the JFET when the voltage at the power capacitor increases to reach a threshold; and
(D) monitoring a voltage at a source of the JFET after the JFET is turned off, for triggering a protection signal.

10. The protection method of claim 9, wherein the step (C) comprises the step of grounding a gate of the JFET when the voltage at the power capacitor increases to reach the threshold.

11. The protection method of claim 9, wherein the step (D) comprises the step of comparing the voltage at the source of the JFET with a brownout threshold.

12. The protection method of claim 9, wherein the step (D) comprises the step of comparing the voltage at the source of the JFET with an over-voltage threshold.

13. The protection method of claim 9, further comprising the step of varying a threshold voltage of the JFET with a voltage at a drain of the JFET after the JFET is turned off.
